(19) United States
(12) Patent Application Publication
(10) Pub. No.: US 2005/0251307 A1
(43) Pub. Date: Nov. 10, 2005

(54) Method for displaying driving-specific data in a motor vehicle

(75) Inventors: Stefan Graf, Markgroeningen (DE); Eger Ulrich, Zaberfeld (DE); Udo Heim, Leonberg (DE); Kluge-Rech Andreas, Frankfurt (DE); Timo Seehaus, Leonberg (DE); Norbert Stelter, Weissach (DE); Hans Weiner, Muehlacker (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing.h.c. F. Porsche, Stuttgart (DE)

(21) Appl. No.: 11/111,877

(22) Filed: Apr. 22, 2005

(30) Foreign Application Priority Data
Apr. 24, 2004 (DE) 10 2004 020 109.9

(51) Int. Cl. G06F 7/00

(52) U.S. Cl. 701/35; 701/1

(57) ABSTRACT

A method for displaying driving-specific data in a motor vehicle, preferably within a driver's visual range, is provided. The display can be switched to a sport mode by a control element (CE) and current lap times can be recorded and stored by an analog and/or digital time recorder that is started and stopped by the driver. From the stored values a reference can be selected in a performance display which is compared with the particular lap time currently being recorded and with the difference between the current lap time and the reference time is displayed.

### BACKGROUND AND SUMMARY OF THE INVENTION

The present invention relates to arrangements for recording driving-specific data.

EP 0 422 022 B1 describes a storage system for connection to a number of analog sensors and for storage of engine and vehicle performance data recorded by the sensors. The engine and vehicle performance data are recorded during a number of selected time periods, with these time periods being automatically started and ended by a device. The data recorded during one time period are stored in a group specific to this time period and compared with the recorded data in another time period in order to draw conclusions on the behavior of the vehicle.

The present invention provides a display for recorded driving-specific data. The data can also be advantageously evaluated and compared, and information about driving behavior can be provided to the driver. In particular, using a timer for recording lap times, it possible to compare the different recorded lap times on a racetrack and, if desired, to perform statistical analyses.

For this purpose, an analog and/or digital timer is provided in the driver's visual range which records the times for presettable distances and is started and/or stopped by the driver via a control unit.

The display of the present invention allows the driver to display the fastest lap and current lap times. Furthermore, a statistical overview of driving behavior can be ascertained throughout the race relative to each individual lap. In accordance with the present invention, a colored display in the cockpit can indicate whether the driver is driving in a range of speed which will attain a set target time.

The display of the invention for representing the different recorded times and their evaluation is illustrated in the figures and will be explained in more detail in the description below.

### BRIEF DESCRIPTION OF THE DRAWING FIGURES

FIG. 1 illustrates a display unit in the driver's visual range for activation of the sport mode with a display of performance, and

FIG. 2 is a schematic diagram of the time recording with evaluation.

### DETAILED DESCRIPTION

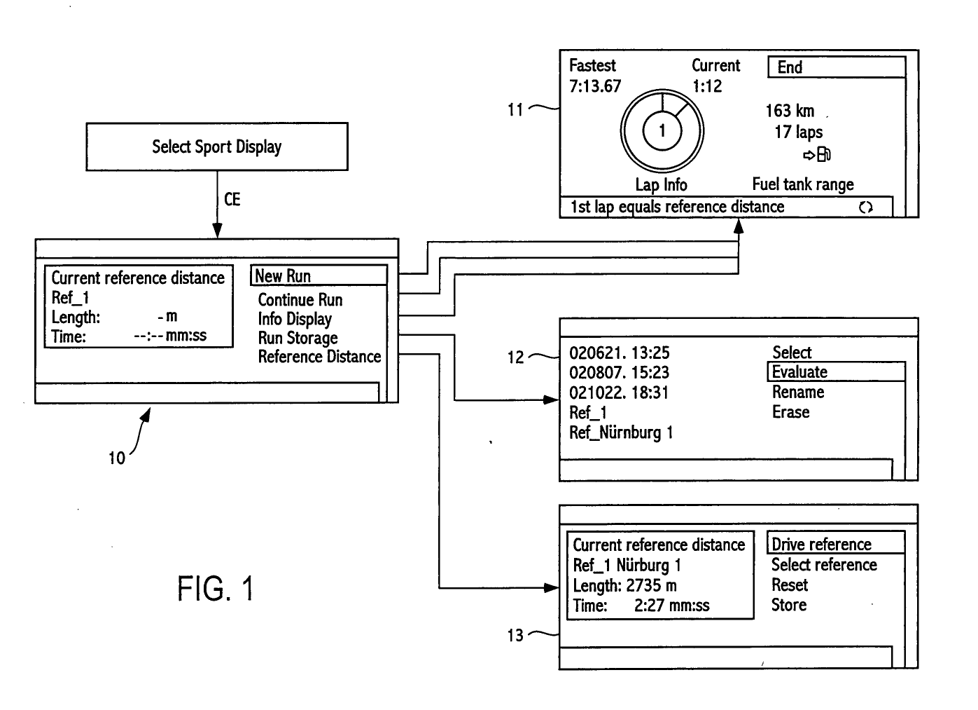

Display screen 10 shown in FIG. 1 is called up by selecting the sport mode. The monitor of a navigation system, for example, serves as a display medium and switches to the display screen 10 after activation of operator control OC. Selection and activation may be done via a lock down knob. Another possible way of switching to and/or selecting different functions in the selected display area is the use of the steering column arm, which is advantageous because it allows the driver rapid access without having to take his hands off the steering wheel. As can be seen from the display 10 menu, the driver can now select different functions. The following are exemplary functions illustrated in FIG. 1:
New Run
Continue Run
Info Display
Run storage
Reference Distance

If the driver selects “New Run”, “Continue Run” or “Info Display”, the display indicated by reference number 11 appears on the screen. Selecting “Run Storage” brings up display 12. In this display, previously recorded values can be displayed and the recorded data evaluated, renamed or erased. The particular function is selected from a list on the right side of the display offering the following choices:
Select
Evaluate
Rename
Erase

On the left side of display 12 there are different reference times, which can then be processed via the selections on the right of the display.

The selection function “Reference Distance” in menu 10 brings up display 13. With this function a reference distance can be recorded or several recorded times of a stored run can be selected. The reference serves for the time and distance comparison of different times, with, for example, a stored run being defined as the reference time and compared with the current run. The driver constantly receives information on the current speed via this comparison with any deviation from the reference speed being displayed.

The current reference distances and times are indicated on the left side of display 13, and the right side offers the driver different possibilities for selecting and activating the following exemplary functions:
Drive Reference
Select Reference
Reset
Store

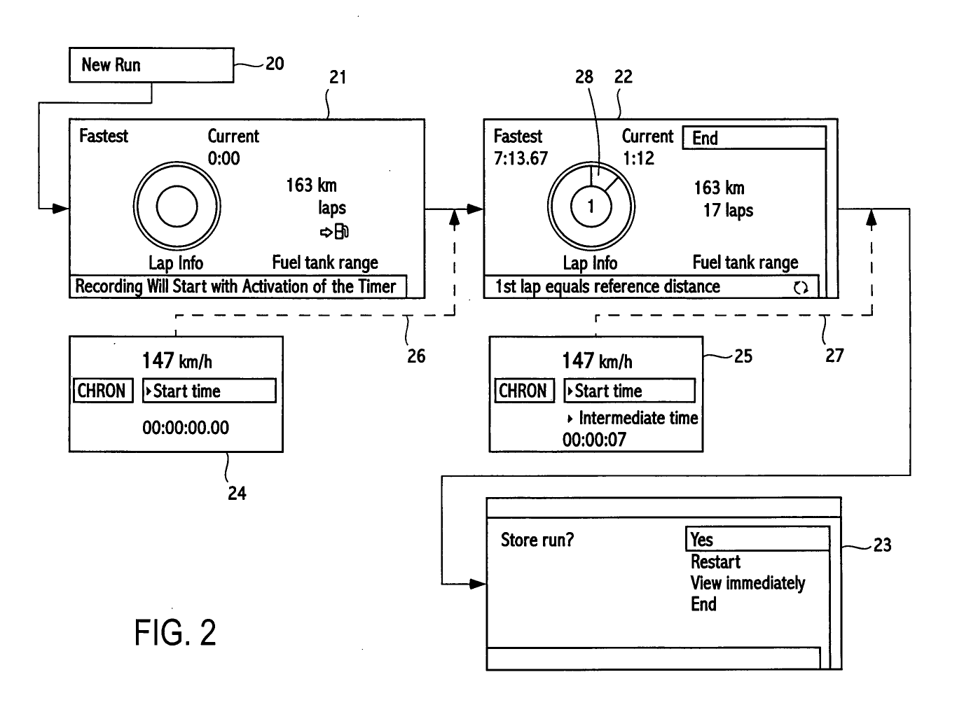

After the sport mode is activated and the screen is switched to display 11, the timer, which is started and stopped by the driver, for example via the steering column switch, is also displayed in a multi-purpose instrument. This display is designated by reference numbers 24 and 25 in FIG. 2.

Lap time recording begins when the timer in the multi-purpose instrument is started, and the different performance display possibilities are described below in connection with FIG. 2.

As explained above, when the sport mode is activated, the screen switches to display 10 which offers the driver various possible selections on the right side of the display. If the driver selects “New Run” 20, the screen switches to the display indicated by reference number 21. This display 21 indicates that the arrangement is ready to record times. In the display 21 illustrated in FIG. 2, the time recording has not yet started and all values are “ZERO” until the current speed is indicated. Here current lap information is displayed in the recording, with both the current time and a reference time being indicated, as well as the current speed and which lap is being driven. As needed, other information or other arrangements of information can also be provided here. At the bottom of the display, the driver is informed that recording will start with activation of the timer. Dotted line 26 indicates that after activation of the timer “Start Time”, the screen for displaying performance indicates the currently driven time, the speed and the current lap, as can be seen from the display with the reference number 22 illustrated in FIG. 2. If no reference time has been defined or selected at the time the time recording begins, the first lap is selected as the new reference lap. In display screen 22, a reference time is already stored and the current lap time (in the example 1:12) is automatically compared with the reference time stored, which is displayed by a color change in lap symbol 28. The color design may be vary according to the type of the deviation. For example, the circle can turn RED for a slower current lap time or GREEN for a faster lap time.

The timer can be stopped via the steering column arm to record an end and/or intermediate time, which is indicated symbolically by dotted line 27.

After the time recording is ended, the lap time can be stored and/or immediately viewed. This remains in memory storage for later selection of the recorded lap times.

The recording and selection of a reference distance make it possible to record each lap separately by means of the timer and to provide a list of all recorded laps after recording is ended. A lap can now be selected from this list as a reference. A reference is a lap which serves as a standard for all laps still to be driven. In this way the system knows how long a lap is and how fast this lap was driven. This evaluation makes it possible to inform the driver rapidly and simply of the quality of the lap currently being driven via the color design, as described above.

If there is no reference list or a reference time is stored, the first lap driven of a new time recording is automatically stored as a reference. The reference display can be advantageously provided with the number of laps (REF1).

The sport display or the performance display has the advantage that the user can record race laps and have different information displayed on each lap. The driver receives information, for example, on how fast the fastest lap was and how the current lap time looks by comparison. Another possibility involves displaying whether he is faster than, as fast as, or slower than his fastest lap and showing this by color.

Although the present invention has been described in connection with particular displays, other displays can be provided. For example, the other displays can be accessed in the menu. By recording widely different parameters and due to the presence of information from the engine control device, the performance display can also indicate how many laps can still be driven at the present fuel-tank level and whether, for example, a critical oil temperature has been reached.

It is also possible to display the number of laps driven and what percentage of the current lap he has already covered, with 100% being a complete lap.

The user of such a performance display can use the indicated functions not only when driving on race tracks but also when driving anywhere, e.g., to work, if the driver regards that distance as one lap.

The system also has the advantage that each record can be stored so that the data can be viewed again at a later time. Such a display can be meaningfully supplemented by an interface to an external analysis unit in order to read out the different data for analysis out of the vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for displaying driving-specific data in a vehicle, comprising the acts of:
switching the display to a sport mode by a control element (CE);
recording current lap times by an analog and/or digital time recorder, which is started and stopped a driver;
selecting a reference time in a performance display;
comparing the selected reference time with a particular lap time currently being recorded; and
displaying a difference between the particular lap time currently being recorded and the selected reference time.

2. The method of claim 1, further comprising the act of:
displaying, by a color design, the difference between the particular lap time currently being recorded and the selected reference time.

3. The method of claim 2, wherein when a current lap time is slower than the selected reference time, the color design is red indication and when a current lap time is faster than the selected reference time the color design is green.

4. The method of claim 1, wherein the time recorder is started by the control element (CE), which is on a steering column arm.

5. The method of claim 1, wherein all recorded lap times are stored and can be retrieved from the storage for statistical analysis, and the data being read out via an interface for external processing and evaluation.

6. The method of claim 1, wherein the display is within the visual range of the driver.

7. A system for displaying driving-specific data in a vehicle, comprising:
a display;
a control element (CE) which can switch the display to a sport mode; and
an analog and/or digital time recorder, which is started and stopped by a driver, and which can recording current lap times,
wherein a reference time is selected in a performance display, the selected reference time is compared with a particular lap time currently being recorded, and a difference between the particular lap time currently being recorded and the selected reference time is displayed on the display.

8. The system of claim 7, wherein the display is a color display, which can display a color design indicating the difference between the particular lap time currently being recorded and the selected reference time.

9. The system of claim 8, wherein when a current lap time is slower than the selected reference time, the color design is red indication and when a current lap time is faster than the selected reference time the color design is green.

10. The system of claim 7, wherein the timer is started by the control element (CE), which is on a steering column arm.

11. The system of claim 7, further comprising:
storage, which stores all recorded lap times are stored and can provide the recorded lap times for statistical analysis; and
an interface which can read out the recorded lap times for external processing and evaluation.

12. The system of claim 7, wherein the display is within the visual range of a driver.
